(19) United States
(12) Patent Application Publication
(10) Pub. No.: US 2011/0268299 A1
(43) Pub. Date: Nov. 3, 2011

(54) SOUND FIELD CONTROL APPARATUS AND SOUND FIELD CONTROL METHOD

(75) Inventor: Mikio Oda, Kyoto (JP)

(73) Assignee: Panasonic Corporation, Osaka (JP)

(21) Appl. No.: 13/143,117

(22) PCT Filed: Dec. 26, 2009
(86) PCT No.: PCT/JP2009/007323

§ 371 Date: Jul. 1, 2011

(30) Foreign Application Priority Data
Jan. 5, 2009 (JP) 2009-000076

(51) Int. Cl. H04R 5/02

(52) U.S. Cl. 381/307

(57) ABSTRACT

A sound field control apparatus, which offers clear sound quality of speech and voice of a center channel signal, a wide service area, and a level easily perceived, and also achieves 5.1 sound image localization and the sense of reality by a two-channel loudspeaker structure, is implemented by a simple structure.

The sound field control apparatus includes: adders (4, 5, 10, 12), a delay unit (9), and an inverting unit (11) for achieving the clear sound quality of speech and voice of a center channel signal; a VCA (3), a maximum value detection unit (6), a level comparison unit (7), and a level control unit (8) for controlling a level to be easily perceived; delay units (15, 16) and sound quality modification equalizers (17, 18) for achieving the same sound quality and sound image localization of surround signals from among 5.1 channel signals by using surround channel loudspeakers so as to obtain 5.1 channel sound image localization and the sense of reality by a two-channel loudspeaker structure; and adders (19, 20) for adding signals as outputs to the located two-channel loudspeakers.

### TECHNICAL FIELD

The present invention relates to sound field control technologies of reproducing a sound field of 5.1 channel signals in reproduction of a multiple-channel sound field. More particularly, the present invention relates to a sound field control technology of reproducing a multiple-channel sound field using a front two-channel loudspeaker system.

### BACKGROUND ART

In reproduction of audio signals by recent audio/visual (AV) devices, development of technologies related to home theaters is active. With wide use of satellite broadcasting and Digital Versatile Discs (DVDs), the number of channels for audio recording/reproduction is increased. For example, a two-channel stereo scheme is developed to 5.1 channel sound field reproduction. In present, the number of channels has further been increased in all directions. For instance, the scheme is developed to 6.1 or 7.1 channel sound field reproduction with additional one or two loudspeakers at the rear of a listener. However, although the number of surround channels is increased, inconvenience of equipment of surround loudspeakers, restriction of a life space which is caused by the equipment, and the like prohibit the surround loudspeakers from being widely used by general users. In order to address the above problems, technologies of controlling expansion of a surround sound field using front loudspeakers are used. Companies develop their own methods of expanding a sound field in order to virtually provide the sense of expanded surround sound and the sense of rear localization without inconvenience of equipping a surround loudspeaker.

FIG. 1 is a diagram showing an example of a conventional sound image expanding device as a typical example of the above-mentioned sound field expanding technologies (see Patent Reference 1).

The following describes operations performed by the conventional sound image expansion device with reference to FIG. 1.

FIG. 1 shows an example of a sound image expansion scheme in the situation where two-channel signals are reproduced by two-channel loudspeakers. The conventional sound image expansion device includes a crosstalk cancelation unit 50, an inverse-phase signal generation unit 60, and a mixing unit 70. The crosstalk cancelation unit 50 generates first left signals Lm1 by removing left crosstalk signals from input L channel signals Lin, and also generates first right signals Rm1 by removing right crosstalk signals from input R channel signals Rin. The inverse-phase signal generation unit 60 generates second left signals Lm2 by mixing inverse-phase signals of the input R channel signals Rin to the input L channel signal Lin, and also generates second right signals Rm2 by mixing inverse-phase signals of the input L channel signals Lin to the input R channel signal Rin. The mixing unit 70 generates left output signals Lout by mixing Lm1 and Lm2, and also generates right output signals Rout by mixing Rm1 and Rm2. FIG. 2 is a block diagram showing a detailed structure of the crosstalk cancelation unit 50 shown in FIG. 1. FIG. 3 is a block diagram showing a detailed structure of the inverse-phase signal generation unit 60 shown in FIG. 1.

FIG. 4 is a diagram for explaining crosstalk signals in the conventional sound image expansion device, explaining how sound reproduced by general two-channel loudspeakers propagates. In FIG. 4, left signals reproduced by a left (L) loudspeaker 71 reaches a left ear of a listener 73 as left direct sound, and also reaches a right ear of the listener 73 as left crosstalk sound. It is considered that a human recognizes a direction of a sound source location of the loudspeaker based on a difference in sound pressure and a difference in time between the direct sound and the crosstalk sound. The crosstalk cancelation unit 50 functions to cancel the crosstalk sound to localize the left signals to the left ear. In addition, the inverse-phase signal generation unit 60 reproduces inverse-phase left signals from the right (R) loudspeaker to reach the right year. Therefore, the sound image of the left signals is expanded to the outside of the left loudspeaker, namely to a location of a virtual LS loudspeaker. With a small processing size, the conventional sound image expansion device can expand a location of a sound image towards the outside of a loudspeaker located in front. The right signals are processed in the same manner as described above, and therefore not explained again.

As described above, the simple crosstalk cancelation and inverse-phase signal generation are performed for input signals to be reproduced by two-channel loudspeakers. Thereby, a sound image can be expanded, and the sense of reality can be thereby easily enhanced in general home.

### PRIOR ARTS

### Patent References

[Patent Reference 1] Japanese Unexamined Patent Application Publication No. 10-66198
[Patent Reference 2] Japanese Unexamined Patent Application Publication No. 5-276598 (described later)

### DISCLOSURE OF INVENTION

### Problems that Invention is to Solve

However, the scheme, by which simple crosstalk cancelation and inverse-phase signal generation are performed using head-related transfer functions of listeners in order to reproduce sound by two-channel loudspeakers, has the following problem. The effect of sound image expansion is expected if a listener is at the center between an L channel loudspeaker and an R channel loudspeaker. However, if the listener is not at the center, the head-related transfer functions are changed so that the crosstalk cancelation is not performed correctly. As a result, it is expected that the effect of sound image expansion is reduced. Furthermore, the scheme does not produce any effect for monaural signals. Even if the technology is employed for 5.1 channel signals, the effect is not produced. In order to facilitate expansion and development of multiple-channel technologies and growth of home theater industries at home in the future, a wide service area and simple equipment of loudspeaker systems are inevitable.

In the multiple-channel reproduction, a center channel signal is used to output audio of speech and voice. In reproduction of contents, speech and voice are important. However, there is a problem that sound effects from surround loudspeakers make it difficult for listeners to perceive such speech and voice.

In order to solve the above conventional problems, an object of the present invention is to provide a sound field control apparatus that (i) ensures clear sound quality of speech and voice of a center channel signal and a sound volume level allowing the speech and voice to be easily perceived, (ii) expands a currently narrow service area, and (iii) achieves 5.1-channel sound image localization and the sense of reality by a two-channel loudspeaker structure in the wide service area.

### Means to Solve the Problems

In accordance with an aspect of the present invention for solving the above problems, there is provided a sound field control apparatus controlling a sound field of input signals including a center channel signal for a center loudspeaker, a left (L) channel signal for a left (L) channel loudspeaker, and a right (R) channel signal for a right (R) channel loudspeaker by using a plurality of loudspeakers including the L channel loudspeaker and the R channel loudspeaker, the center loudspeaker being located in front of a listening location, the L channel loudspeaker being located to front left of the listening location, the R channel loudspeaker being located to front right of the listening location, and the sound field control apparatus including: a level comparison unit configured to compare a level of the center channel signal to a maximum value of levels of a plurality of other signals included in the input signals; a volume control amplifier increasing or decreasing the level of the center channel signal; and a level control unit configured to control the volume control amplifier to increase the level of the center channel signal when the level comparison unit determines by the comparison that the level of the center channel signal is lower than the maximum value.

It is also possible that the sound field control apparatus further includes: a first adder adding the center channel signal having the level increased or decreased by the volume control amplifier to the L channel signal to be provided to the L channel loudspeaker; and a second adder adding the center channel signal having the level increased or decreased by the volume control amplifier to the R channel signal to be provided to the R channel loudspeaker, wherein the level control unit is configured to control the volume control amplifier to (i) increase the level of the center channel signal gradually to a predetermined upper limit level when the level comparison unit determines by the comparison that the level of the center channel signal is lower than the maximum value, and (ii) decrease the level of the center channel signal gradually to an original level prior to the increasing when the level comparison unit determines by the comparison that the level of the center channel signal is higher than the maximum value.

It is further possible that the sound field control apparatus further includes: a first delay unit configured to delay, by a predetermined time period, the center channel signal having the level increased or decreased by the volume control amplifier to output a delay signal; and an inverting unit configured to invert the delay signal outputted from the first delay unit to output an inverted signal, wherein one of the first adder and the second adder adds the delay signal outputted from the first delay unit to one of the L channel signal and the R channel signal, and other one of the first adder and the second adder adds the inverted signal outputted from the inverting unit to other one of the L channel signal and the R channel signal.

It is still further possible that the input signal further includes a side surround Left Surround (LS) channel signal for a side surround Left Surround (LS) channel loudspeaker and a side surround Right Surround (RS) channel signal for a side surround Right Surround (RS) channel loudspeaker in addition to the center channel signal, the L channel signal, and the R channel signal, the side surround LS channel loudspeaker being located to rear left of the listening location, and the side surround RS channel loudspeaker being located to rear right of the listening location, the sound field control apparatus further including: a first sound quality modification equalizer modifying sound quality of the side surround LS channel signal and delaying the side surround LS channel signal having the modified sound quality; and a second sound quality modification equalizer modifying sound quality of the side surround RS channel signal and delaying the side surround RS channel signal having the modified sound quality, wherein the first adder adds an output signal of the first sound quality modification equalizer to the L channel signal, the second adder adds an output signal of the second sound quality modification equalizer to the R channel signal, and the level comparison unit is configured to compare the level of the center channel signal to a maximum value of levels of the side surround LS channel signal, the side surround RS channel signal, the L channel signal, and the R channel signal.

It is still further possible that the first sound quality modification equalizer modifies the sound quality of the side surround LS channel signal based on a difference between (a) frequency characteristics of sound pressure from (a1) a location at which sound image of the side surround LS channel signal is to be localized to (a2) the listening location and (b) frequency characteristics of sound pressure from a location of the L channel loudspeaker to the listening location, and the second sound quality modification equalizer modifies the sound quality of the side surround RS channel signal based on a difference between (a) frequency characteristics of sound pressure from (a1) a location at which sound image of the side surround RS channel signal is to be localized to (a2) the listening location and (b) frequency characteristics of sound pressure from a location of the R channel loudspeaker to the listening location.

It is still further possible that the input signals further include a subwoofer signal, the first adder adds the subwoofer signal to the L channel signal, and the second adder adds the subwoofer signal to the R channel signal.

It is still further possible that the sound field control apparatus further includes: a second delay unit configured to delay, by a predetermined time period, the L channel signal included in the input signals; and a third delay unit configured to delay, by a predetermined time period, the R channel signal included in the input signals, wherein the first adder adds the center channel signal having the level increased or decreased by the volume control amplifier to the L channel signal delayed by the second delay unit, and the second adder adds the center channel signal having the level increased or decreased by the volume control amplifier to the R channel signal delayed by the third delay unit.

In accordance with another aspect of the present invention for solving the above problems, there is provided a sound field control method of controlling a sound field of input signals including a center channel signal for a center loudspeaker, a left (L) channel signal for a left (L) channel loudspeaker, and a right (R) channel signal for a right (R) channel loudspeaker by using a plurality of loudspeakers including the L channel loudspeaker and the R channel loudspeaker, the center loudspeaker being located in front of a listening location, the L channel loudspeaker being located to front left of the listening location, the R channel loudspeaker being located to front right of the listening location, and the sound field control method including: comparing, by a level comparison unit, a level of the center channel signal to a maximum value of levels of a plurality of other signals included in the input signals; selectively increasing and decreasing, by a volume control amplifier, the level of the center channel signal; and controlling, by a level control unit, the volume control amplifier to increase the level of the center channel signal when the level comparison unit determines by the comparing that the level of the center channel signal is lower than the maximum value.

It should be noted that the present invention can be implemented not only as the device, but also as: a method including steps performed by the processing units included in the device: a program causing a computer to execute these steps; a computer-readable recording medium, such as Compact Disc Read Only Memory (CD-ROM), on which the program is recorded: information, data, or signals indicating the program; and the like. The program, information, data, and signals may be distributed by a communication network such as the Internet.

### Effects of the Invention

The sound field control apparatus according to the present invention has the above-described simple structure to (i) offer clear sound quality of speech and voice of a center channel signal and a sound volume level allowing the speech and voice to be easily perceived, (ii) ensure a wide service area for a plurality of listeners, and (iii) achieve 5.1-channel sound image localization and the sense of reality by a two-channel loudspeaker structure.

### BRIEF DESCRIPTION OF DRAWINGS

FIG. 1 is a block diagram of a conventional sound image expanding device.

FIG. 2 is a block diagram of a crosstalk cancelation unit in the conventional sound image expanding device.

FIG. 3 is a block diagram of an inverse-phase signal generation unit in the conventional sound image expanding device.

FIG. 4 is a diagram for explaining principles of the conventional sound image expanding device.

FIG. 5A is an external view of an example of a content reproduction apparatus including a sound field control apparatus according to the present invention.

FIG. 5B is an external view of an example of a content reproduction apparatus including the sound field control apparatus according to the present invention.

FIG. 6 is a block diagram showing a structure of a sound field control apparatus according to an embodiment of the present invention.

FIG. 7 is a block diagram of main processing units which perform level control of a center channel signal in the sound field control apparatus according to the embodiment of the present invention.

FIG. 8 (a), (b), (c) in FIG. 8 are charts indicating output signals of a level comparison unit, an integrator, a level control unit, respectively, in level control of a center channel signal according to the embodiment of the present invention.

FIG. 9 is a flowchart of processing in level control of a center channel signal which is performed by the sound field control apparatus according to the embodiment of the present invention.

FIG. 10 is a block diagram showing a minimum structure required to perform level control of a center channel signal according to the embodiment of the present invention.

FIG. 11 is a block diagram showing main processing units which cancel frequency characteristics of sound pressure due to interference of in-phase center channel signals in the sound field control apparatus according to the embodiment of the present invention.

FIG. 12 is a diagram for explaining occurrence of a loudspeaker distance difference depending on a listening location.

FIG. 13 is a graph plotting frequency characteristics of sound pressure resulting from interference of in-phase center channel signals.

FIGS. 14 (a) and (b) in FIG. 14 are graphs plotting frequency characteristics of sound pressure of a left output and a right output, respectively, resulting from delay effects of delay units shown in FIG. 11.

FIGS. 15 (a) and (b) in FIG. 15 are graphs each plotting frequency characteristics of sound pressure depending upon a listening angle which indicates (i) frequency characteristics of sound pressure resulting from interference of in-phase center channel signals and (ii) a result of improving the characteristics according to the embodiment of the present invention.

FIG. 16 is a block diagram of an example of improvement of cancelation in the conventional two-channel signal system.

FIG. 17 is a block diagram showing main processing units which modify frequency characteristics of sound pressure of side surround signals in the sound field control apparatus according to the embodiment of the present invention.

FIG. 18 is a diagram of a loudspeaker layout recommended by International Telecommunication Union Radiocommunications Sector (ITU-R) BS. 775-1.

FIG. 19 is an explanatory diagram showing a sound image localization direction of a surround loudspeaker in a plasma TV according to the embodiment of the present invention.

FIG. 20 is an explanatory diagram of loudspeaker locations for explaining operation principles of the embodiment of the present invention.

FIG. 21 is a graph of frequency characteristics of sound pressure for explaining operation principles of the embodiment of the present invention.

FIG. 22 is a graph of showing modification characteristics of frequency characteristics of sound pressure of a sound quality modification equalizer according to the embodiment of the present invention.

FIG. 23 is an explanatory diagram of sound image localization in a plasma TV according to the embodiment of the present invention.

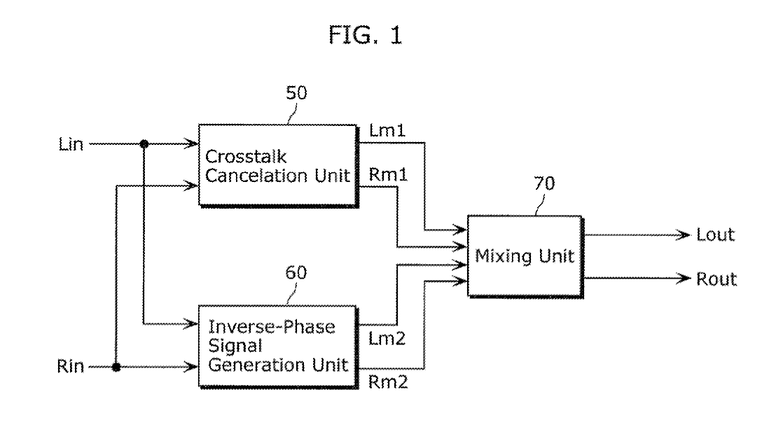

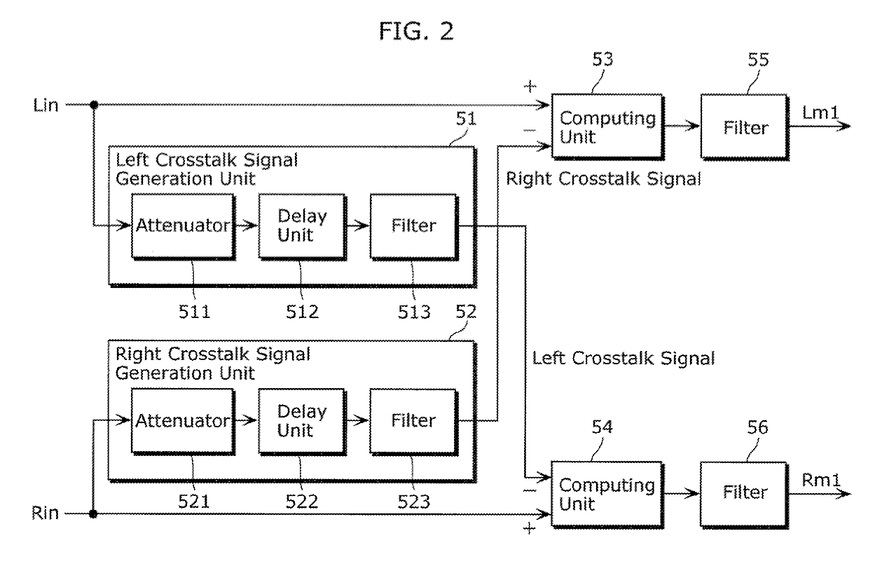

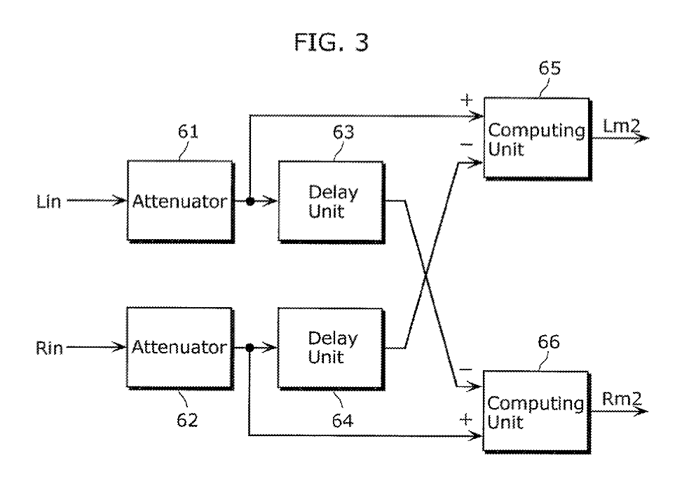

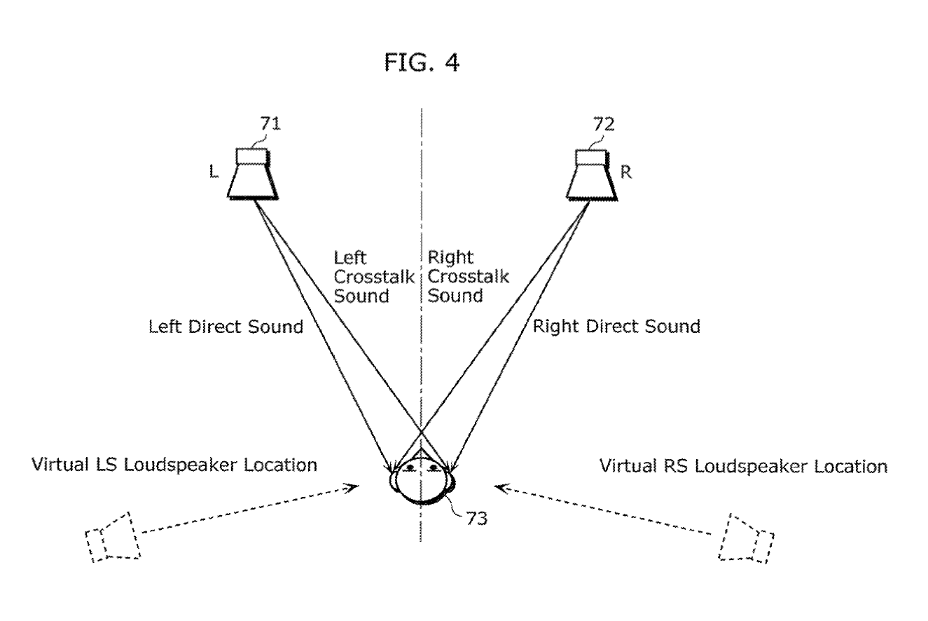

### BEST MODE FOR CARRYING OUT THE INVENTION

The following describes the best embodiment according to the present invention with reference to the drawings.

### First Embodiment

Detailed description is given for processing and structural elements of a sound field control apparatus according to the embodiment of the present invention.

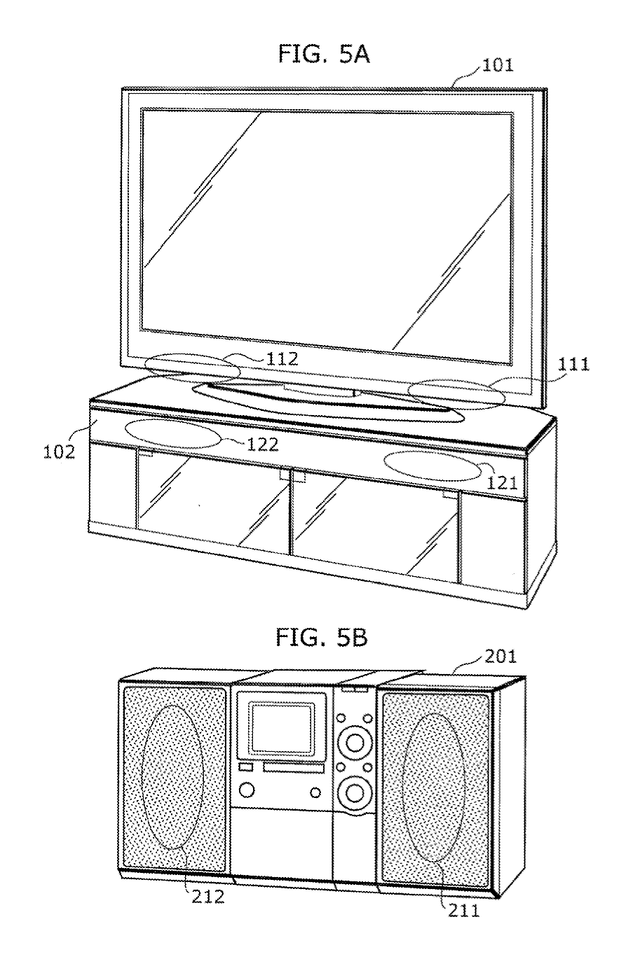

Each of FIGS. 5A and 5B is an external view of an example of a content reproduction apparatus including the sound field control apparatus according to the present invention. FIG. 5A is an external view of a television set 101 and a rack theater 102 which include the sound field control apparatus according to the present invention. The television set 101 includes loudspeakers side by side at a right loudspeaker location 111 and a left loudspeaker location 112 below its monitor screen. The rack theater 102 also includes loudspeakers side by side at a right loudspeaker location 121 and a left loudspeaker location 122 in a sound bar located at an upper front portion of the rack theater 102. Each of the loudspeakers in the rack theater 102 has a bore larger than that of each of the loudspeakers in the television set 101. FIG. 5B is an external view of an audio component To 201 including the sound field control apparatus according to the present invention. The audio component 201 includes loudspeakers at a right loudspeaker location 211 and a left loudspeaker location 212. These loudspeakers have large bores for full-fledged audio reproduction. Each of the television set 101, the rack theater 102, and the audio component 201 includes the sound field control apparatus according to the present invention, so that, by using the two loudspeakers, they can reproduce a center channel signal having clear sound quality and an adequate sound volume, and also reproduce 5.1 channel signals in a wide service area.

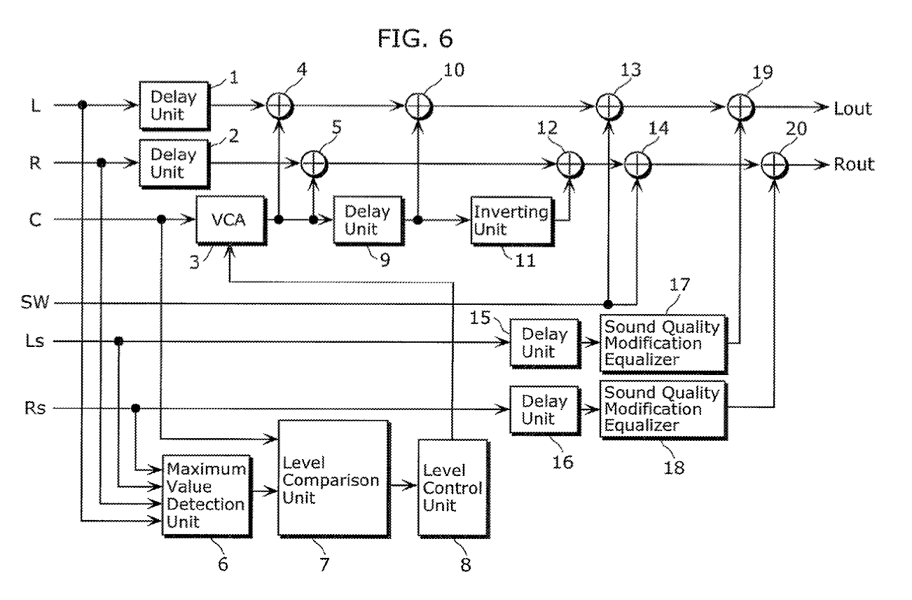

FIG. 6 is a block diagram showing a structure of a sound field control apparatus according to the embodiment of the present invention. The sound field control apparatus shown in FIG. 6 reproduces, by using two-channel loudspeakers, 5.1 channel signals consisting of a Left (L) channel signal (L signal), a Right (R) channel signal (R signal), a center channel signal (C signal), a side surround Left Surround (LS) channel signal (Ls signal), a side surround Right Surround (RS) channel signal (Rs signal), and a subwoofer channel signal (SW signal).

As shown in FIG. 6, the sound field control apparatus includes delay units 1 and 2, a volume control amplifier (VCA) 3, adders 4 and 5, a maximum value detection unit 6, a level comparison unit 7, a level control unit 8, a delay unit 9, an adder 10, an inverting unit 11, adders 12, 13, and 14, delay units 15 and 16, sound quality modification equalizers 17 and 18, and adders 19 and 20. The delay unit 1 delays the L signal and the delay unit 2 delays the R signal. The VCA 3 controls a level of the C signal. The adder 4 adds an output signal of the delay unit 1 with an output signal of the VCA 3, and the adder 5 adds an output signal of the delay unit 2 with the output signal of the VCA 3. The maximum value detection unit 6 is implemented as, for example, a maximum value circuit using a logic circuit or an ideal diode circuit. An output of the maximum value detection unit 6 is a signal having a maximum level of an input. If the maximum value detection unit 6 is implemented as software, the maximum value detection unit 6 includes a memory such as a register to temporarily store signal values of the L, R, Ls, and Rs signals except the C signal among 5.1 channel signals. Thereby, the maximum value detection unit 6 detects a maximum value among levels of the stored signals. The maximum value detection unit 6 outputs the detected maximum-level signal. The level comparison unit 7 compares the C signal to an output signal of the maximum value detection unit 6. The level control unit 8 controls the VCA 3 based on an output signal of the level comparison unit 7. The delay unit 9 delays an output signal of the VCA 3. The adder 10 adds an output signal of the adder 4 with an output signal of the delay unit 9. The inverting unit 11 inverts an output signal of the delay unit 9. The adder 12 adds an output signal of the adder 5 with an output signal of the inverting unit 11. The adder 13 adds an output signal of the adder 10 with the SW signal, and the adder 14 adds an output signal of the adder 12 with the SW signal. The delay unit 15 delays the Ls signal, and the delay unit 16 delays the Rs signal. The sound quality modification equalizer 17 modifies sound quality of an output signal of the delay unit 15, and the sound quality modification equalizer 18 modifies sound quality of an output signal of the delay unit 16. The adder 19 adds an output signal of the adder 13 with an output signal of the sound quality modification equalizer 17, and the adder 20 adds an output signal of the adder 14 with an output signal of the sound quality modification equalizer 18. It should be noted in FIG. 6 that it has been described that the adders 4, 10, 13, and 19 adds the L channel signal with the level-controlled C signal, a Cτ signal generated by time-delaying the level-controlled C signal, SW signal, and Ls signal with modified sound quality characteristics, respectively. However, these adders 4, 10, 13, and 19 are not necessary to be separate different units, but may form the same adder 19. Likewise, it has been described that the adders 5, 12, 14, and 20 adds the R channel signal with the level-controlled C signal, the Cτ signal generated by time-delaying and inverting the level-controlled C signal, SW signal, and Rs signal with modified sound quality characteristics, respectively. However, these adders 5, 12, 14, and 20 are not necessary to be separate different units, but may form the same adder 20. Or, these adders may be appropriately combined to be a single adder. For example, it is possible to design to combine the adders 4 and 10 together, and the adders 5 and 12 together. It should also be noted that the delay unit 15 and the sound quality modification equalizer 17 may be connected in reverse order, or may perform their processing at the same time. It should also be noted that the delay unit 16 and the sound quality modification equalizer 18 may be connected in reverse order, or may perform their processing at the same time.

First, signal processing for controlling a level of the center channel signal (hereinafter, referred to as “signal processing for level control”) is described.

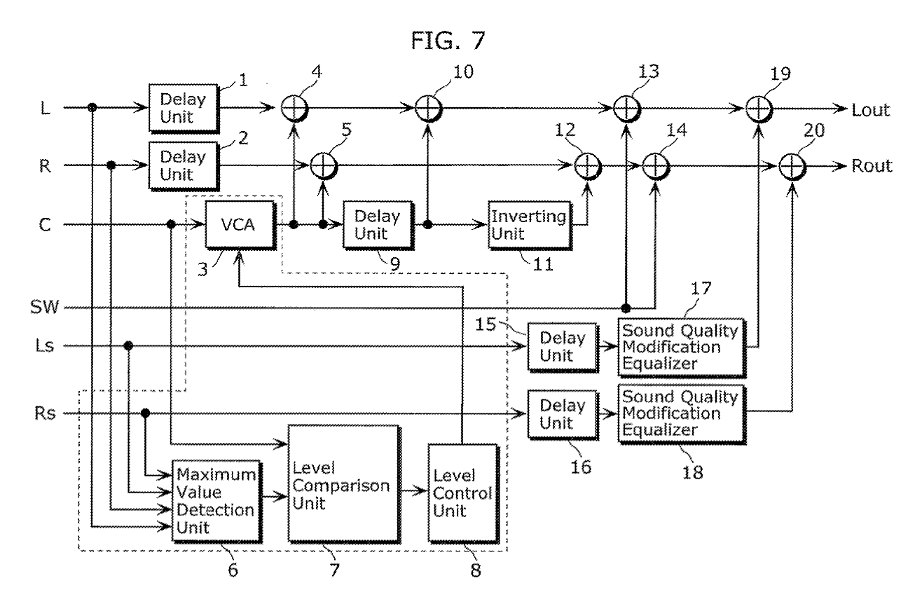

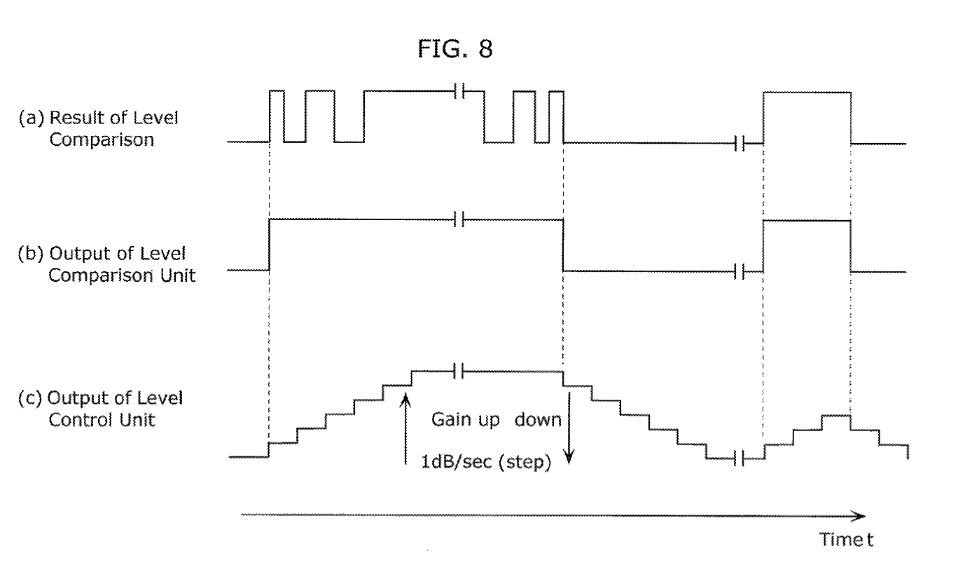

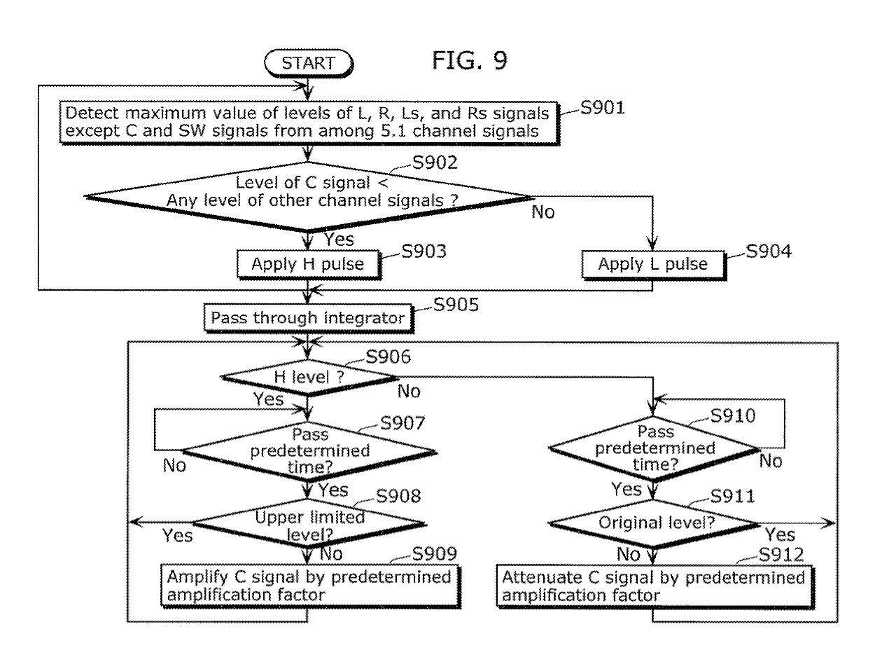

FIG. 7 is a diagram showing main processing units which performs level control of the center channel signal in the sound field control apparatus according to the embodiment of the present invention. In FIG. 7, a part of the structure shown in FIG. 6 which performs signal processing for controlling a level of the center channel signal is surrounding by a dotted line. FIG. 8 is a chart indicating output signals of the level comparison unit 7 and the level control unit 8 in the signal processing for controlling a level of the center channel signal. FIG. 9 is a flowchart showing signal processing for controlling a level of the center channel signal which is performed by the maximum value detection unit 6, the level comparison unit 7, and the level control unit 8. As shown in FIGS. 6 and 7, the maximum value detection unit 6 detects a maximum level from among levels of the input L signal, R signal, Ls signal, and Rs signal (S901). The level comparison unit 7 compares the maximum level detected by the maximum value detection unit 6 to a level of the C signal. The level comparison unit 7 thereby determines whether the level of the C signal is higher or lower than the maximum level of the other sound effect channels (S902). As shown in (a) in FIG. 8, if the level is lower than the maximum level, then high (H) pulse is generated (S903), and if the level is equal to or higher than the maximum level, then low (L) pulse is generated (S904). Here, the sound field control apparatus returns to Step S901 to repeat the processing from Step S901 to Step S904. At the same time, the level comparison unit 7 applies, as shown in (b) of FIG. 8, the generated pulse through the integrator absorbing chattering to the level control unit 8 (S905).

In receiving an output of the level comparison unit 7 through the integrator at Step S905, the level control unit 8 sets, as is shown in (c) of FIG. 8, the level of amplification to be gradually increased to a predetermined maximum amplification amount (6 dB, for example), and causes the VCA 3 to control the level accordingly.

In more detail, the level control unit 8 includes, for example, a register for a count of steps of amplifying the C signal. The level control unit 8 increments or decrements the count stored in the register for each amplification step or attenuation step, and stores the current count of the amplification steps of the C signal into the register. The level control unit 8 determines whether or not an output of the integrator of the level comparison unit 7 is at high (H) level (S906). If the output is at H level, the level control unit 8 waits for a predetermined time period, for example, one second (S907). After passing the predetermined time period, the level control unit 8 resets a timer and then determines whether or not an amplification factor of the level of the C signal reaches an upper limit level, for example, 6 dB (S908). If the amplification factor reaches the upper limit level, then the processing returns to Step S906. Otherwise, the level control unit 8 increments a count of steps of amplifying the C signal by a predetermined amplification factor, for example, by 1 dB, in other words, increments the count of amplifying steps which is stored in the register by 1 (S909). Then, the processing returns to Step S906.

At Step S906, if the output of the integrator is not at H level, namely, is at low (L) level (No at Step S906), then the level control unit 8 waits for a predetermined time period, for example, one second (Step S910). After passing the predetermined time period, the level control unit 8 resets the timer and then determines whether or not the level of the C signal is the same as its original level (Step S911). If the level is the same as the original level, in other words, if its amplification factor is 0 dB, then the processing returns to Step S906. Otherwise, the level control unit 8 attenuates the steps of amplifying the C signal by a predetermined amplification factor, for example, by 1 dB, so as to decrement the count stored in the register by 1 (S912). Then, the processing returns to Step S906.

As described above, sudden increase to a predetermined maximum amplification amount of 6 dB causes the listener to notice sudden and frequent difference between switched sound volumes due to determination errors and instant determination. Therefore, the level of the C signal is gradually controlled by 1 dB step/second, as described above. When it takes a short time period to perform the determination, the level of the C signal does not need to reach the maximum amplification amount. Thus, especially the C signal is an important signal indicating speech and voice. In the case that a level of the C signal is lower than other effect channels, vital speech is sometimes lost among the sound effects and cannot be perceived. Therefore, the C signal is reproduced with a higher level in order to reproduce the center channel signal sound with a sound volume level which can be easily perceived. It should be noted that it has been described that a level of the C signal is controlled to be amplified up to 6 dB gradually by 1 dB step/second when the output of the integrator is at H level, and controlled to be attenuated from 6 dB to 0 dB gradually by 1 dB step/second when the output of the integrator is at L level. However the present invention is not limited to the above. The numeral values presented above are merely preferable examples, and any numeral values can be set. For example, it is also possible that the level control unit 8 previously has a look-up table holding groups each including (a) a value of an upper limit level (maximum amplification amount), (b) an amplification factor gradually amplified or attenuated, and (c) a time interval, for example. According to an input from the outside by a user, the level control unit 8 may select one of the groups to control a level of the C signal. Therefore, for instance, it is possible that, a level of the C signal is amplified or attenuated by 0.5 dB for each 0.5 second for one user, but by 1 dB for each 1 second for another user.

It should also be noted that it has been described in the above example that multiple 5.1 channel signals are reproduced by two-channel loudspeakers. However, the present invention is not limited to that. For example, the present invention can be applied also in the case that multiple 3 channel signals are reproduced by two-channel loudspeakers. For instance, the present invention can be applied when multiple-channel signals consisting of the C signal, the L channel signal, and the R channel signal are reproduced by an L channel loudspeaker and an R channel loudspeaker. In this case, the level comparison unit 7 may compare the C signal to a signal having a maximum level detected by the maximum value detection unit 6 from among the L and R signals except the C signal, so as to output H pulse or L pulse indicating a result of the comparison.

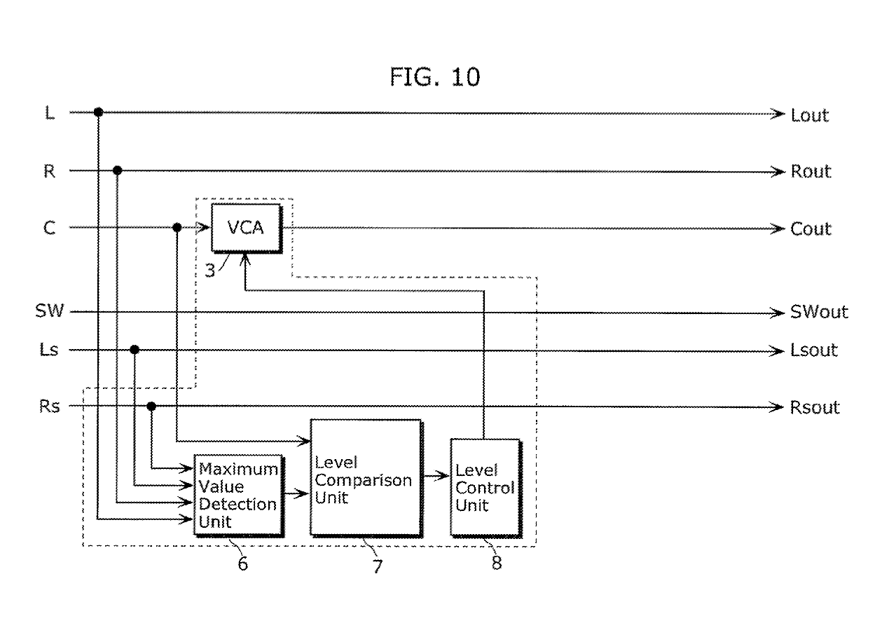

FIG. 10 is a block diagram showing a minimum structure required to perform level control of the center channel signal according to the embodiment of the present invention. Although FIG. 7 shows the structure of the sound field control apparatus which reproduces multiple 5.1 channel signals by two loudspeakers, the present invention is not limited to the above. For example, as shown in FIG. 10, a method of controlling a level of the C signal according to the embodiment of the present invention can be used also in a multiple-channel audio reproduction apparatus that reproduces 5.1 channel signals by six loudspeakers. Of course, the method of controlling a level of the C signal according to the embodiment of the present invention can be used also in a multiple-channel audio reproduction apparatus that reproduces 3 channel signals by three loudspeakers. In this case, the level comparison unit 7 compares the C signal to a signal having a maximum level detected by the maximum value detection unit 6 from the L and R signals except the C signal, so as to output H pulse or L pulse indicating a result of the comparison.

It should be noted that it has been described in the above example that an output of the maximum value detection unit 6 is a signal having a maximum level detected from levels of the L, R, Ls, and Rs signals except the C signal, but the present invention is not limited to the above. For example, an output of the maximum value detection unit 6 is not necessarily a signal having a maximum level detected from the levels of L, R, Ls, and Rs signals except the C signal. It may be a value of the maximum level of the signal. In this case, the level comparison unit 7 compares a level of the C signal with a value of a signal having a maximum level among the L, R, Ls, and Rs signals.

It should also be noted that it has been described in the above example that the inverting unit 11 is connected between the delay unit 9 and the adder 12, but, of course, the inverting unit 11 may be connected between a connection point branched from the delay unit 9 and the adder 10.

Next, signal processing for center channel signals is described.

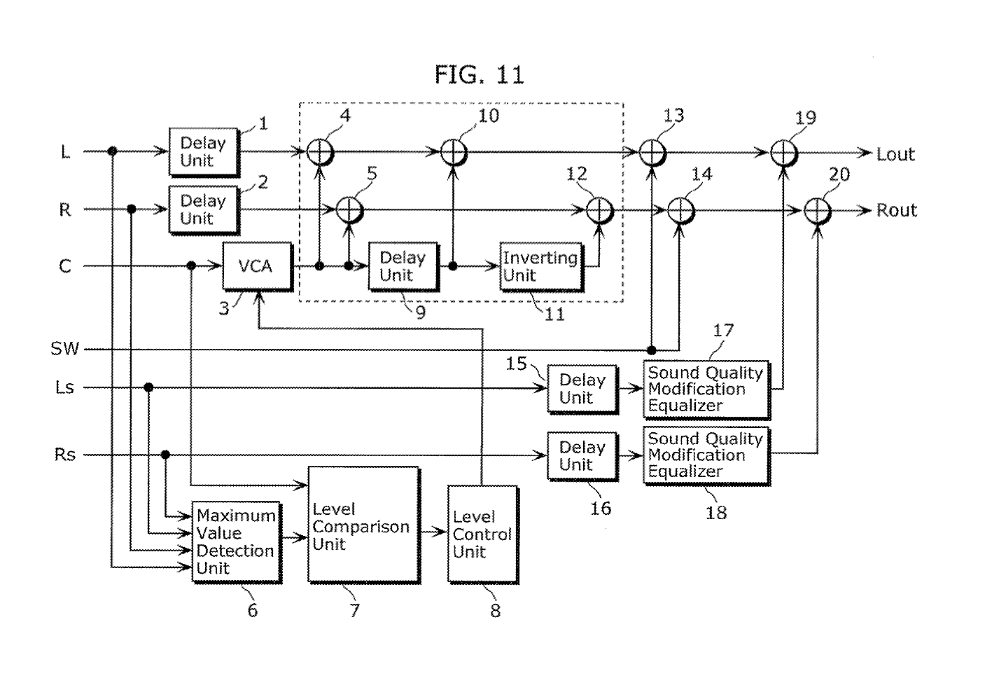

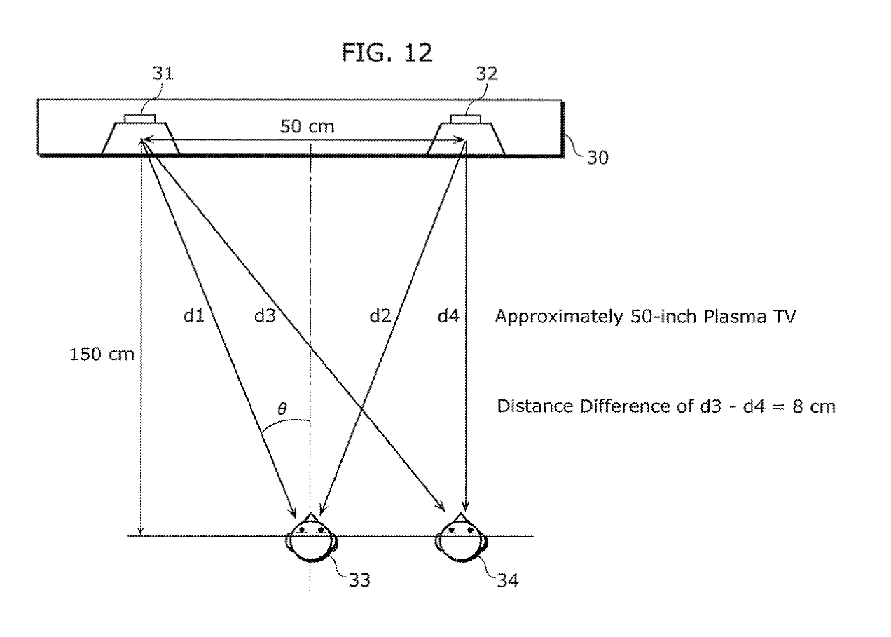

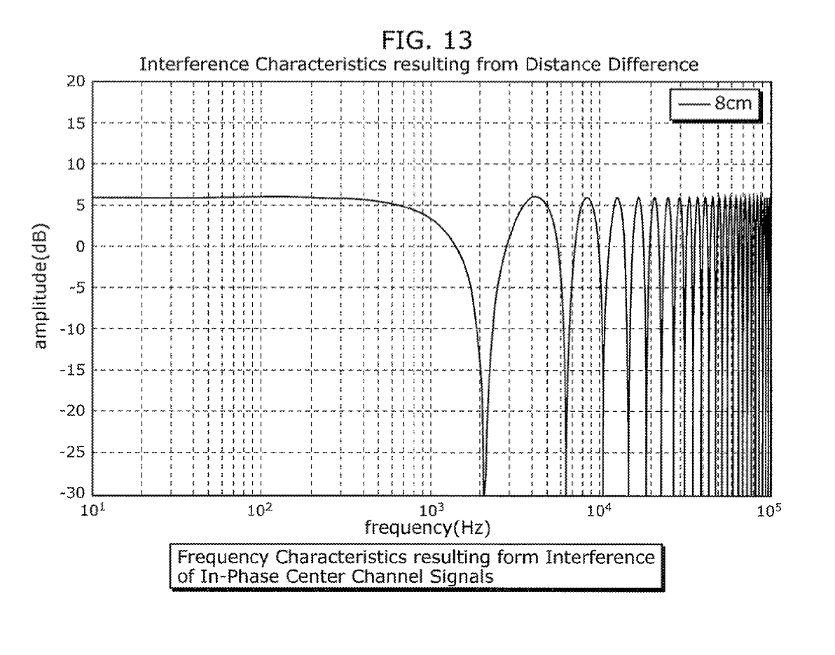

FIG. 11 is a diagram showing main processing units which cancel frequency characteristics of sound pressure resulting from interference of in-phase center channel signals in the sound field control apparatus according to the embodiment of the present invention. FIG. 12 is a diagram for explaining occurrence of a loudspeaker distance difference depending on a listening location. FIG. 13 is a graph plotting frequency characteristics of sound pressure resulting from interference of in-phase center channel signals. In general, when center channel signals are down-mixed for a two-channel loudspeaker system, the signals are added as in-phase signals to each of the L channel loudspeaker 31 and the R channel loudspeaker 32. Here, it is assumed that a listener 33 watches and listens to a plasma TV set 30 away from the plasma TV set 30 by a listening distance of 1.5 m, and that the plasma TV set 30 has a size of 50 inches and includes left and right loudspeakers apart from each other by a distance of 50 cm. Under the assumption, from the listener 33 just in front of the plasma TV set 30, a distance d1 to the L channel loudspeaker 31 is equal to a distance d2 to the R channel loudspeaker 32 (namely, distance d1=distance d2). Therefore, there is no difference between the distances to the respective left and right loudspeakers.

Next, it is assumed that a listener 34 watches and listens to the same plasma TV set 30 in front of the R channel loudspeaker 32. Under the assumption, a distance d3 from the listener 34 to the L channel loudspeaker 31 is not equal to a distance d4 from the listener 34 to the R channel loudspeaker 32 (namely, distance d3≠distance d4). Therefore, a difference between the distances to the respective left and right loudspeakers is

d3−d4=8 cm.

When the same sound is reproduced by the L channel loudspeaker 31 and the R channel loudspeaker 32 having the distance difference of 8 cm, cancelation having frequency characteristics of sound pressure occurs due to interference of in-phase signals as shown in FIG. 13. More specifically, the first cancelation dip appears near a frequency of 2.1 KHz having a half wavelength of 8 cm, and other cancelation dips appear also for its odd-number-fold frequencies. On the other hand, its even-number-fold frequencies are accumulating peaks each increased by 6 dB. Thereby, at a location of the listener (hereinafter, referred to as a “listening location”), irregularity occurs in the frequency characteristics of sound pressure. Especially the center channel signal is an important signal indicating speech and voice. Therefore, it is required to ensure a wide service area where sound can be reproduced clearly without irregularity of frequency characteristics of sound pressure resulting from such distance difference of loudspeakers from the listening location.

Therefore, as shown in FIG. 11, the input C signals are added to the L channel and R channel by the adders 4 and 5, respectively, via the VCA 3. At the same time, the center channel signals are time-delayed by the delay unit 9 and added by the adder 10 to the L channel. In addition, the center channel signals which are time-delayed by the delay unit 9 are inversed by the inverting unit 11 to have an inverse phase, and then added by the adder 12 to the R channel.

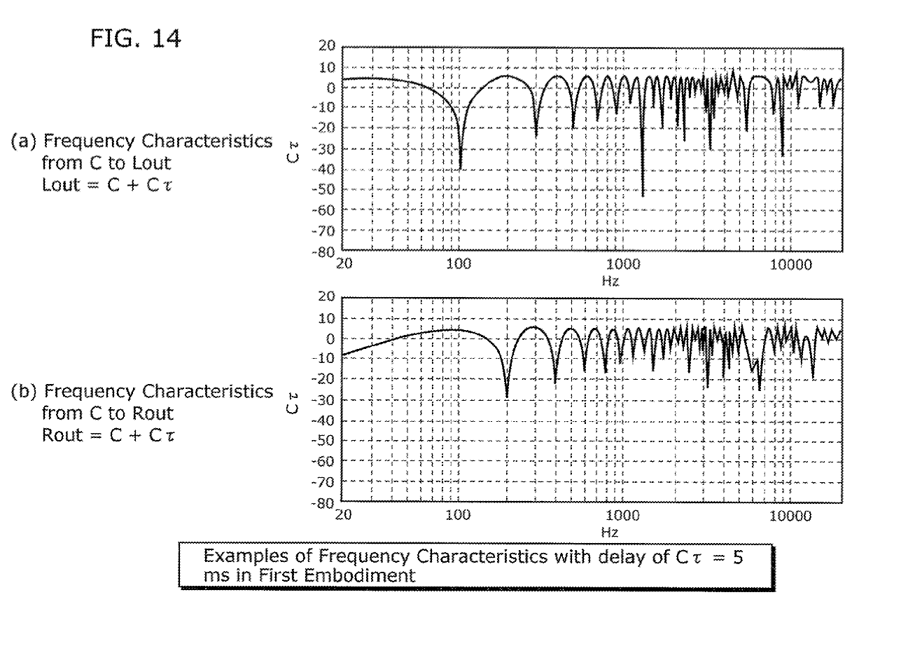

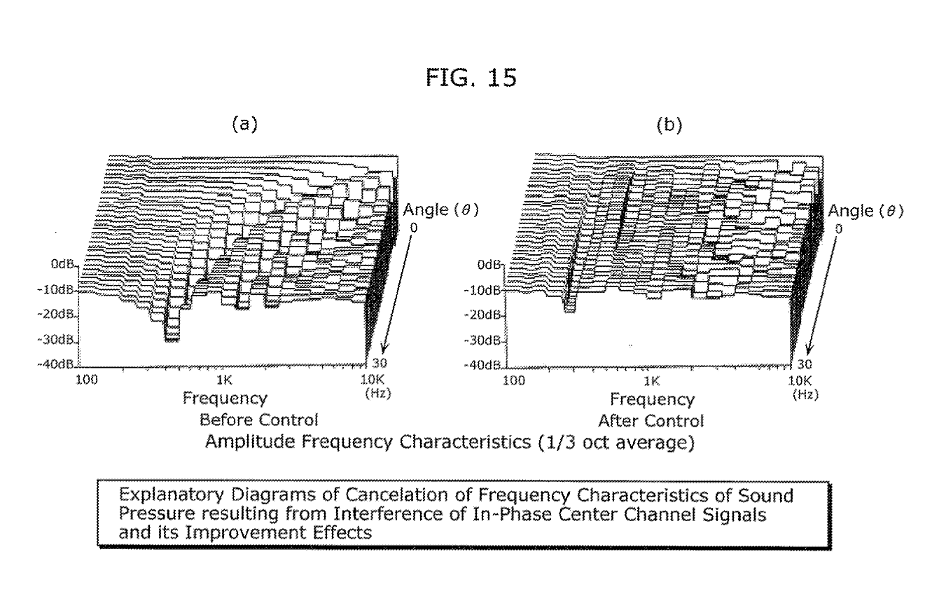

Here, assuming that the delay time amount of the delay unit 9 is represented by τ, and an output of the delay unit 9 is represented by Cτ, the input C signals are converted to a Lout signal and a Rout signal, respectively, expressed by the below equations, in order to be added to the L channel and the R channel, respectively. FIG. 14 shows graphs plotting frequency characteristics of sound pressure of a left output and a right output, respectively, resulting from delay effects of the delay units shown in FIG. 11. (a) and (b) in FIG. 15 are graphs each plotting frequency characteristics of sound pressure depending upon a listening angle which indicates (i) frequency characteristics of sound pressure resulting from interference of in-phase center channel signals and (ii) a result of improving the characteristics according to the embodiment of the present invention.

Lout=C+Cτ

Rout=C−Cτ

When a delay time is correctly processed by digital processing to set the delay time amount τ to be 5 ms (milliseconds), frequency characteristics of sound pressure of Lout and Rout resulting from the delay effects are analyzed as follows, as shown in FIG. 14.

Lout: a dip at a frequency of 100 Hz, a peak at a frequency of 200 Hz, a dip at a frequency of 300 Hz, . . . .

Rout: a peak at a frequency of 100 Hz, a dip at a frequency of 200 Hz, a peak at a frequency of 300 Hz, . . . .

As a result, positions of peaks and dips of frequency characteristics of sound pressure are opposite between Lout and Rout. (b) of FIG. 15 shows an example where the above processing is performed, the listening angle (location) is shifted to another, sound is reproduced, and eventually frequency characteristics of sound pressure are measured. As shown in (a) of FIG. 15, in the case of Lout=Rout=C, the frequency characteristics of sound pressure of the C signal that is cancelled as in-phase signals due to a listening angle is finely uncorrelated by adding delay signals +Cτ and −Cτ. As a result, as shown in (b) of FIG. 15, any listening angles do not cause large peaks and dips.

As described above, it has conventionally been disclosed that the addition of a signal already delayed to an original signal not yet been delayed can improve in-phase signal cancelation (see Patent Reference 2).

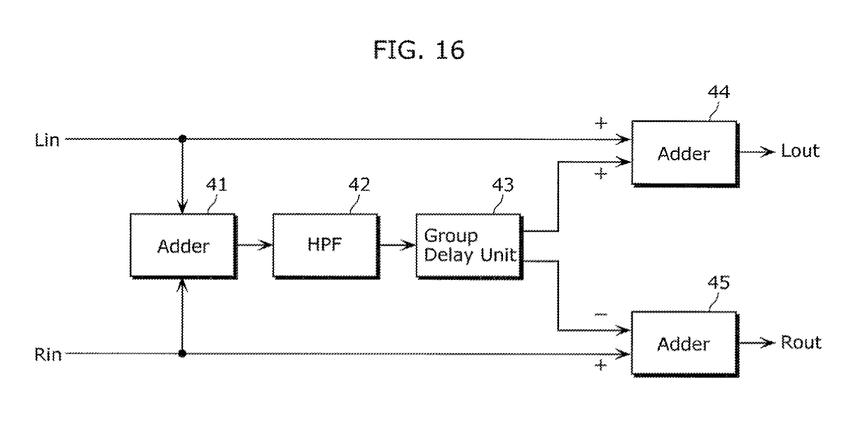

FIG. 16 is a block diagram showing an example of improvement of the conventional in-phase signal cancelation in a conventional two-channel signal system. In FIG. 16, an adder 41 detects in-phase signals of the L and R signals. Then, a High Pass Filter (HPF) 42 detects high-frequency components from the in-phase signals. A group delay unit 43 delays the high-frequency components. Adders 44 and 45 add the delayed components to the L and R signals, respectively. In the embodiment of the present invention, a digital delay unit capable of setting a correct delay time is used as the delay unit 9 corresponding to the group delay unit 43. Thereby, by using the in-phase signal processing in the conventional two-channel signal system, it is possible to improve interference of the center channel signal having higher performance. As a result, it is possible to achieve center channel reproduction with a wide service area and sound quality easily perceived.

Next, signal processing for surround channel signals is described.

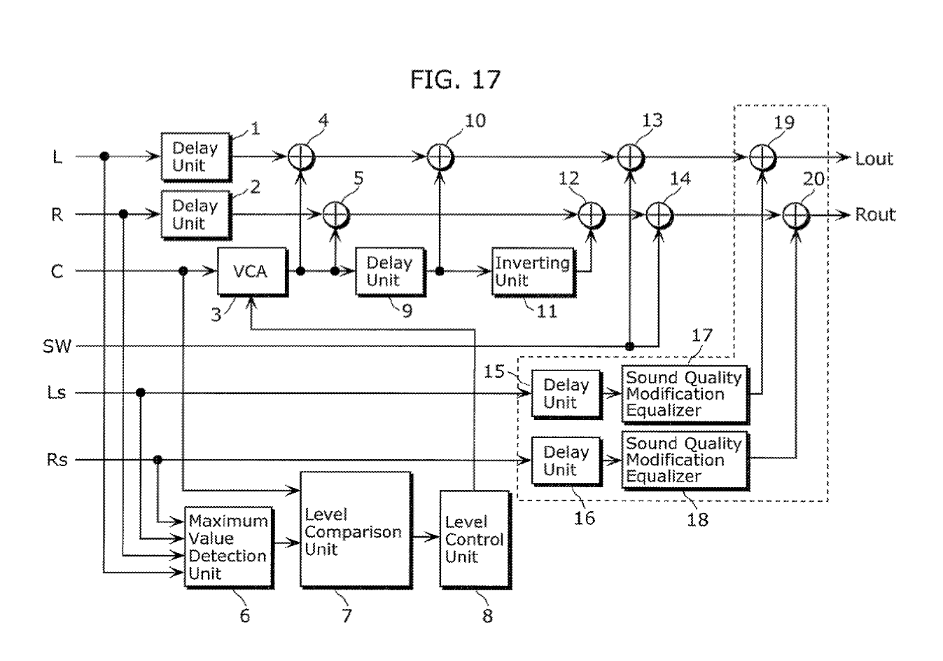

FIG. 17 is a block diagram showing main processing units which modify frequency characteristics of sound pressure in order to localize a side surround LS channel signal and a side surround RS channel signal to a phantom side surround LS channel loudspeaker and a phantom side surround RS channel signal loudspeaker, respectively, in the sound field control apparatus according to the embodiment of the present invention. In FIG. 17, the main processing units which perform sound image localization for the side surround LS channel signal and the side surround RS channel signal are surrounded by a dotted line. In the sound field control apparatus according to the embodiment of the present invention, the Ls signal from among input 5.1 channel signals is time-delayed by the delay unit 15 in order to temporally differentiate a sound image localization location with reference to the C signal, the L signal, and the R signal. Sound quality of the signal time-delayed by the delay unit 15 is modified by the sound quality modification equalizer 17. The resulting signal is added by the adder 19 to the L channel signal. Likewise, the Rs signal from among input 5.1 channel signals is time-delayed by the delay unit 16 in order to temporally differentiate a sound image localization location with reference to the C signal, the L signal, and the R signal. Sound quality of the signal time-delayed by the delay unit 16 is modified by the sound quality modification equalizer 18. The resulting signal is added by the adder 20 to the R channel signal. Each of the delay units 15 and 16 delays a target signal by the same time delay amount of approximately several ms to several dozens ms. Each of the sound quality modification equalizers 17 and 18 has the same frequency characteristics of sound pressure. In other words, the time delay amount of the delay units 15 and 16 may be set to be an optimum value within the above-mentioned range from several ms to several dozens ms, in consideration of valance among output signals in the entire circuit of the sound field control apparatus. FIG. 17 shows that the Ls signal is delayed by the delay unit 15 and then processed by the sound quality modification equalizer 17 to modify sound quality, and that the Rs signal is delayed by the delay unit 16 and then processed by the sound quality modification equalizer 18 to modify sound quality. However, the present invention is not limited to the above. The connection order of the delay units 15 and 16 and the sound quality modification equalizers 17 and 18 may be exchanged. In other words, it is also possible that the Ls signal is first processed by the sound quality modification equalizer 17 to modify frequency characteristics of sound pressure, and then delayed by the delay unit 15 to be provided to the adder 19. The same goes for the Rs signal.

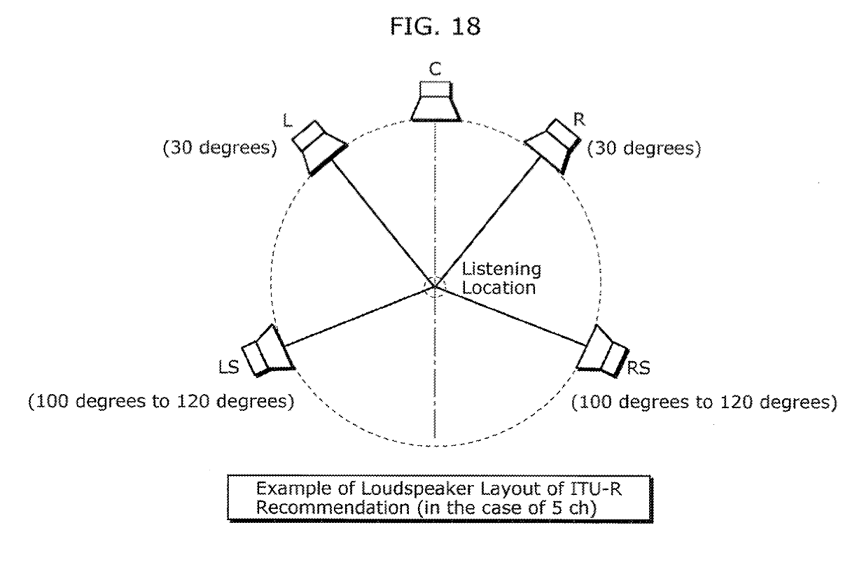

FIG. 18 is a diagram of a loudspeaker layout recommended by ITU-R BS. 775-1. The following describes a modification method of the sound quality modification equalizers 17 and 18. In general, a 5.1 channel loudspeaker layout is based on the loudspeaker layout recommended by ITU-R BS. 775-1, as shown in FIG. 18. More specifically, each of an L channel loudspeaker and an R channel loudspeaker is located in a direction at 30 degrees in front of a listener, and each of side surround loudspeakers is located at 110 degrees behind the listener.

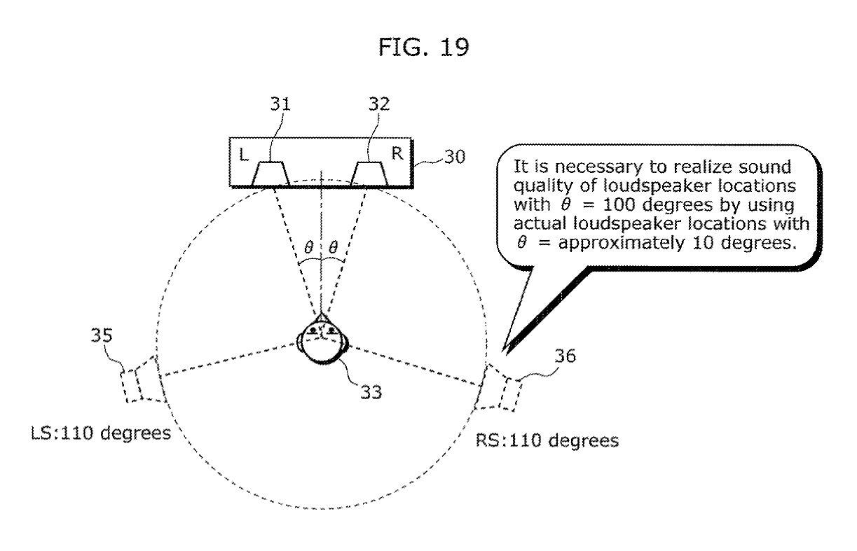

FIG. 19 is an explanatory diagram showing a sound image localization direction of each surround loudspeaker in the plasma TV set according to the embodiment of the present invention. However, to as a real problem, when a listener listens to the plasma TV set 30, a listening angle θ between (a) the direction to the front of the listener and (b) each of (b-1) the direction to the front L channel loudspeaker 31 and (b-2) the direction to the front R channel loudspeaker 32 is approximately 10 degrees as shown in FIG. 19. Therefore, by using these front loudspeakers located in respective directions at 10 degrees from the front of the listener (hereinafter, referred to simply as “from the listener” or “from the listening location”), it is necessary to virtually localize a phantom side surround LS channel loudspeaker 35 and a phantom side surround RS channel loudspeaker 36 in a direction at 110 degrees from the listener. The modification is performed by the sound quality modification equalizers 17 and 18.

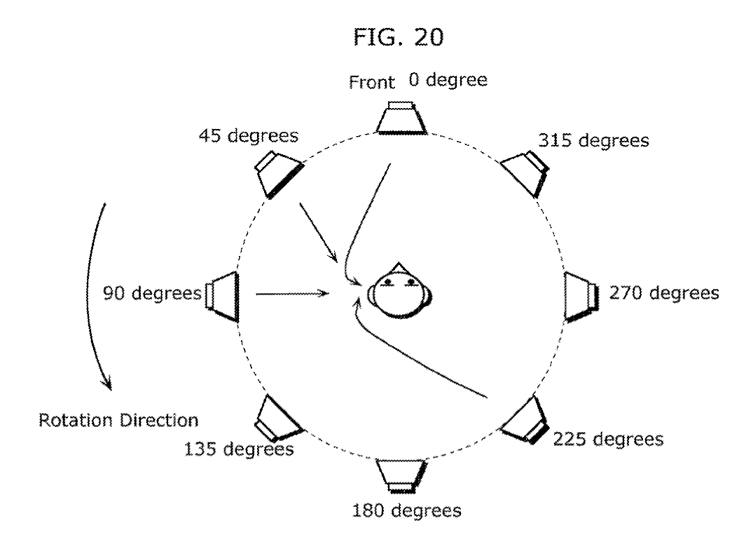

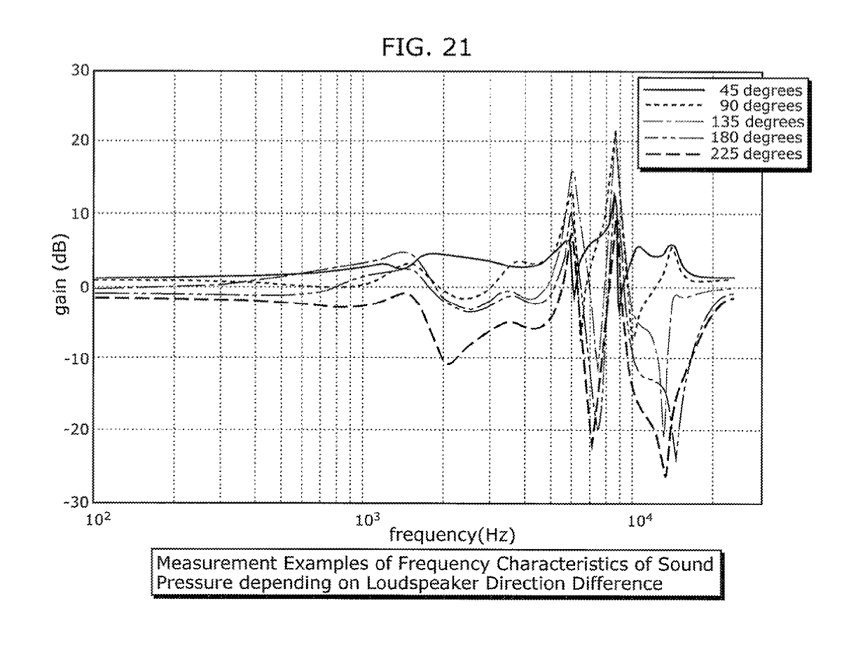

FIG. 20 is a diagram showing a method of measuring frequency characteristics of sound pressure from a location of each loudspeaker located along a circumference of the same circle with a center that is a listener to a left ear of the listener so as to examine a relationship between each listening direction and frequency characteristics of sound pressure. As shown in FIG. 20, in order to measure frequency characteristics of sound pressure of loudspeakers, a plurality of loudspeakers having the same characteristics are located around a location of a listener (listening location), and a simulated human head having a dummy head microphone at an entrance of an ear canal is placed at the listening location. As a result, actual examples of the measuring are shown in FIG. 21.

FIG. 21 is a graph plotting results of measuring a difference as between frequency characteristics of sound pressure related to a direction at 0 degree from the listener and frequency characteristics of sound pressure related to a direction at each angle from the listener when the same loudspeakers are located around the listening location for each 45-degree difference. The results of the measurements of FIG. 21 show the following. In a frequency range of 1 kHz or higher, a high frequency is lowered as a locating angle of the loudspeaker is increased. In a frequency range of 6 kHz or higher, fine peaks/dips exist. They are variation of the frequency characteristics of sound pressure due to a head-related transfer function, which is known to be caused by diffraction and interference of sound due to shapes of a head and an auditory capsule. Paying attention to the variation of the frequency characteristics of sound pressure, in the embodiment of the present invention, the phantom side surround LS channel loudspeaker 35 and the phantom side surround RS channel loudspeaker 36 shown in FIG. 19 are located at respective locations at 110 degrees from the listening location.

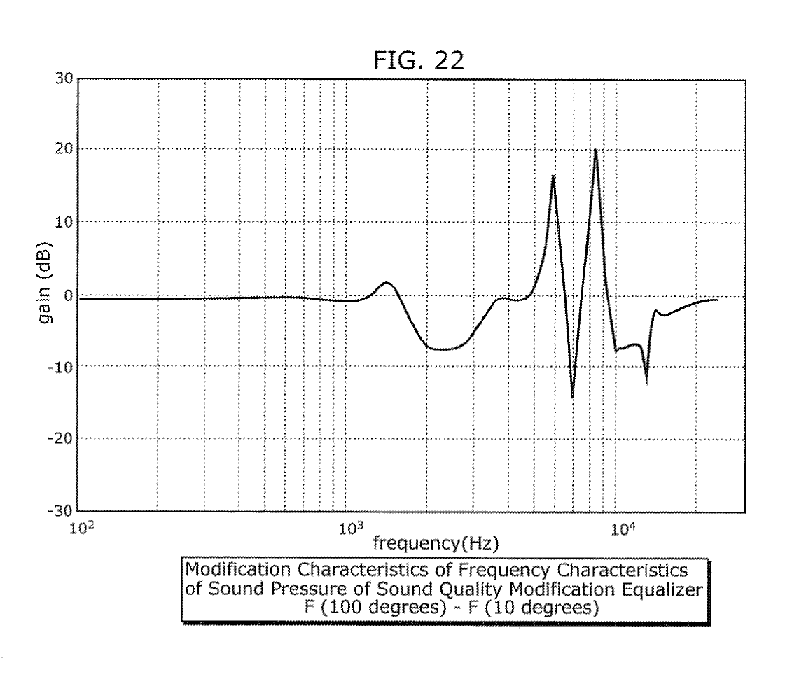

FIG. 22 is a graph plotting characteristics in modifying frequency characteristics of sound pressure (hereinafter, referred to as “modification characteristics of frequency characteristics of sound pressure”) in order to localize the Ls and Rs signals provided from the respective L and R loudspeakers at locations at 10 degrees from the listening location to left and right locations at 110 degrees from the listening location, respectively. In order to localize the phantom side surround LS channel loudspeaker 35 and the phantom side surround RS channel loudspeaker 36 to the respective locations at 110 degrees from the listening location, each of the sound quality modification equalizers 17 and 18 has modification characteristics EQ1 of frequency characteristics of sound pressure which are expressed by

EQ1=F(110 degrees)−F(10 degrees)

where F (θ) represents frequency characteristics of sound pressure with an angle θ, and the subtraction means subtraction using dB values, namely, subtraction on a logarithmic axis.

Based on the principle, modification characteristics EQ2 of frequency characteristics of sound pressure of sound quality modification equalizers for the phantom L channel loudspeaker and the phantom R channel loudspeaker to be located at respective locations at 30 degrees from (a) the direction to the front of the listening location to (b) each of (b-1) the direction to the L channel loudspeaker and (b-2) the direction to the R channel loudspeaker are expressed by

EQ2=F(30 degrees)−F(10 degrees).

However, since there is almost no difference between the frequency characteristics related to a direction at 30 degrees from the listening location and the frequency characteristics related to a direction at 10 degrees from the listening location, the sound quality modification equalizers are not used.

When, as described above, angles of locations of loudspeakers for phantom localization are expected, and signals to be localized are synthesized to be localized by real loudspeakers at loudspeaker locations having the respective angles, the sound quality modification equalizers modify frequency characteristics of sound pressure according to a difference in sound quality resulting from the difference in angles of loudspeaker locations. Thereby, even for signals reproduced by the same L channel loudspeaker and R channel loudspeaker, it is possible to differentiate the L channel signal and the R channel signal from the side surround Ls signal and the side surround Rs signal based on the difference in sound quality.

In addition, since the same L channel loudspeaker outputs the C signal and the time-delayed Ls signal, the delay unit 1 performs delay processing to temporally differentiate a sound image localization location of the L signal. Likewise, since the same R channel loudspeaker outputs the C signal and the time-delayed Rs signal, the delay unit 1 performs delay processing to temporally differentiate a sound image localization location of the R signal. A delay time delayed by the delay units 1 and 2 is recommended to be approximately 20 ms, but may be an optimum value in a range substantially from 20 ms to 50 ms.

Moreover, the input SW signal is added by the adders 13 and 14 to L channel and R channel, respectively, to be down-mixed to the two channels to be reproduced.

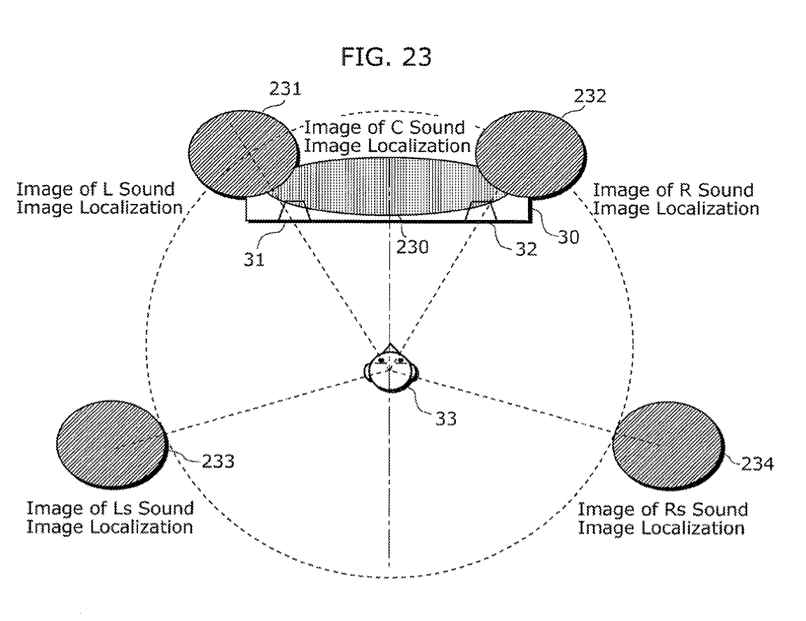

FIG. 23 is a diagram of showing an image of sound image localization locations in the plasma TV set 30 according to the embodiment of the present invention. As shown in hatched parts in FIG. 23, a sound image of the L signal is localized in a space region 231 behind of the L channel loudspeaker 31, and a sound image of the R signal is localized in a space region 232 behind of the R channel loudspeaker 32. Furthermore, a sound image of the Ls signal is localized in a space region 233 in a direction at 110 degrees to the left and behind a listener, and a sound image of the Rs signal is localized in a space region 234 in a direction at 110 degrees to the right and behind the listener. A sound image of the C signal is localized at a location of a space region 230 shown by a hatched part with vertical lines. In other words, the sound image of the C signal is localized to be wide in a left-right direction between the L channel loudspeaker 31 and the R channel loudspeaker 32.

As described above, in the sound field control apparatus according to the embodiment of the present invention, the center channel signal is delayed to be an uncorrelated signal and down-mixed to be reproduced by a two-channel loudspeakers. Thereby, the frequency characteristics of sound pressure that are canceled as in-phase signals due to a listening location, are set to be flat for any listening locations. As a result, the reproduced sound with clear sound quality can be offered in a wide service area. Moreover, a level of the C signal is compared to levels of other sound effect signals. In the case that a level of the C signal is lower than the levels of other sound effects signals, the C signal is amplified and reproduced. Thereby, it is possible to increase a level of an important signal regarding speech and voice more than the sound effects. As a result, the sound of speech and voice can be reproduced to be easily perceived. Furthermore, a surround signal is processed to be modified using frequency characteristics of sound pressure that depend on a listening location, and then added to two-channel loudspeakers. As a result, by using such a simple signal processing structure, a two-channel loudspeaker structure can obtain 5.1 channel sound image localization and the sense of reality. The modification is performed only for the frequency characteristics of sound pressure without using detailed signal sound synthesis or crosstalk cancelation employing a FIR filter for a single listener employing a head-related transfer function. Therefore, the service is offered not for a particular listener, but to a wide service area with a plurality of listeners.

It should be noted that functional blocks in the block diagrams (FIGS. 6, 10, 16, etc.) are typically implemented into a Large Scale Integration (LSI) which is an integrated circuit. These may be integrated separately, or a part or all of them may be integrated into a single chip.

For example, functional blocks except a memory may be integrated into a single chip.

Here, the integrated circuit is referred to as a LSI, but the integrated circuit can be called an IC, a system LSI, a super LSI or an ultra LSI depending on their degrees of integration.

The technique of integrated circuit is not limited to the LSI, and it may be implemented as a dedicated circuit or a general-purpose processor. It is also possible to use a Field Programmable Gate Array (FPGA) that can be programmed after manufacturing the LSI, or a reconfigurable processor in which connection and setting of circuit cells inside the LSI can be reconfigured.

Furthermore, if due to the progress of semiconductor technologies or their derivations, new technologies for integrated circuits appear to be replaced with the LSIs, it is, of course, possible to use such technologies to implement the functional blocks as an integrated circuit. For example, biotechnology and the like can be applied to the above implementation.

Note also that only a means for storing data to be coded or decoded, among these functional blocks, may be realized as another structure, without being integrated into the single chip.

### INDUSTRIAL APPLICABILITY

The sound field control apparatus according to the present invention can offer clear sound quality of speech and voice of a center channel signal and lisetenability of a sound volume level of the center channel signal, thereby ensuring a service area for a plurality of listeners. In addition, the sound field control apparatus can achieve sound image localization of 5.1 channel signals and the sense of reality by a two-channel loudspeaker structure. Moreover, the modification only for frequency characteristics of sound pressure and the simple addition operation synthesis performed by the sound field control apparatus can simplify a signal processing circuit. Thereby, the sound field control apparatus is useful to easily equip loudspeaker systems with the future increase of multi-channel technologies. Especially, the sound field control apparatus is useful to ensure a wide service area that is inevitable for popularization of sound systems.

More specifically, the sound field control apparatus according to the present invention is useful for multi-channel content is reproduction apparatuses that reproduce the center channel signal to be easily perceived, and more particularly for television sets, rack theaters, and audio components which perform multi-channel reproduction of 5.1 channel signals using two-channel loudspeakers.

### NUMERICAL REFERENCES

1, 2 delay unit
3 VCA
4, 5 adder
6 maximum value detection unit
7 level comparison unit
8 level control unit
9 delay unit
10 adder
11 inverting unit
12 adder
13, 14 adder
15, 16 delay unit
17, 18 sound quality modification equalizer
19, 20 adder
30 plasma TV set
31 L channel loudspeaker
32 R channel loudspeaker
33, 34 listener
35 phantom side surround LS channel loudspeaker
36 phantom side surround RS channel loudspeaker
41 adder
42 HPF
43 group delay unit
44, 45 adder
50 crosstalk cancelation unit
51 left crosstalk signal generation unit
52 right crosstalk signal generation unit
53, 54 computing unit
55, 56 filter
60 inverse-phase signal generation unit
61, 62 attenuator
63, 64 delay unit
65, 66 computing unit
70 mixing unit
71 left (L) loudspeaker
72 right (R) loudspeaker
73 listener
101 television set
102 rack theater
111, 121, 211 right loudspeaker location
112, 122, 212 left loudspeaker location
230, 231, 232, 233, 234 space region
201 audio component
511, 521 attenuator
512, 522 delay unit
513, 523 filter

1. A sound field control apparatus controlling a sound field of input signals including a center channel signal for a center loudspeaker, a left (L) channel signal for a left (L) channel loudspeaker, and a right (R) channel signal for a right (R) channel loudspeaker by using a plurality of loudspeakers including the L channel loudspeaker and the R channel loudspeaker, the center loudspeaker being located in front of a listening location, the L channel loudspeaker being located to front left of the listening location, the R channel loudspeaker being located to front right of the listening location, and said sound field control apparatus comprising:
a level comparison unit configured to compare a level of the center channel signal to a maximum value of levels of a plurality of other signals included in the input signals;
a volume control amplifier increasing or decreasing the level of the center channel signal; and
a level control unit configured to control said volume control amplifier to increase the level of the center channel signal when said level comparison unit determines by the comparison that the level of the center channel signal is lower than the maximum value.

2. The sound field control apparatus according to claim 1, further comprising:
a first adder adding the center channel signal having the level increased or decreased by said volume control amplifier to the L channel signal to be provided to the L channel loudspeaker; and
a second adder adding the center channel signal having the level increased or decreased by said volume control amplifier to the R channel signal to be provided to the R channel loudspeaker,
wherein said level control unit is configured to control said volume control amplifier to (i) increase the level of the center channel signal gradually to a predetermined upper limit level when said level comparison unit determines by the comparison that the level of the center channel signal is lower than the maximum value, and (ii) decrease the level of the center channel signal gradually to an original level prior to the increasing when said level comparison unit determines by the comparison that the level of the center channel signal is higher than the maximum value.

3. The sound field control apparatus according to claim 1, further comprising:
a first delay unit configured to delay, by a predetermined time period, the center channel signal having the level increased or decreased by said volume control amplifier to output a delay signal; and
an inverting unit configured to invert the delay signal outputted from said first delay unit to output an inverted signal,
wherein one of said first adder and said second adder adds the is delay signal outputted from said first delay unit to one of the L channel signal and the R channel signal, and
other one of said first adder and said second adder adds the inverted signal outputted from said inverting unit to other one of the L channel signal and the R channel signal.

4. The sound field control apparatus according to claim 1,
wherein the input signal further includes a side surround Left Surround (LS) channel signal for a side surround Left Surround (LS) channel loudspeaker and a side surround Right Surround (RS) channel signal for a side surround Right Surround (RS) channel loudspeaker in addition to the center channel signal, the L channel signal, and the R channel signal, the side surround LS channel loudspeaker being located to rear left of the listening location, and the side surround RS channel loudspeaker being located to rear right of the listening location,
said sound field control apparatus further comprising:
a first sound quality modification equalizer modifying sound quality of the side surround LS channel signal and delaying the side surround LS channel signal having the modified sound quality; and
a second sound quality modification equalizer modifying sound quality of the side surround RS channel signal and delaying the side surround RS channel signal having the modified sound quality,
wherein said first adder adds an output signal of said first sound quality modification equalizer to the L channel signal,
said second adder adds an output signal of said second sound quality modification equalizer to the R channel signal, and
said level comparison unit is configured to compare the level of the center channel signal to a maximum value of levels of the side surround LS channel signal, the side surround RS channel signal, the channel signal, and the R channel signal.

5. The sound field control apparatus according to claim 4,
wherein said first sound quality modification equalizer modifies the sound quality of the side surround LS channel signal based on a difference between (a) frequency characteristics of sound pressure from (a1) a location at which sound image of the side surround LS channel signal is to be localized to (a2) the listening location and (b) frequency characteristics of sound pressure from a location of the L channel loudspeaker to the listening location, and
said second sound quality modification equalizer modifies the sound quality of the side surround RS channel signal based on a difference between (a) frequency characteristics of sound pressure from (a1) a location at which sound image of the side surround RS channel signal is to be localized to (a2) the listening location and (b) frequency characteristics of sound pressure from a location of the R channel loudspeaker to the listening location.

6. The sound field control apparatus according to claim 1,
wherein the input signals further include a subwoofer signal,
said first adder adds the subwoofer signal to the L channel signal, and
said second adder adds the subwoofer signal to the R channel signal.

7. The sound field control apparatus according to claim 1, further comprising:
a second delay unit configured to delay, by a predetermined time period, the L channel signal included in the input signals; and
a third delay unit configured to delay, by a predetermined time period, the R channel signal included in the input signals,
wherein said first adder adds the center channel signal having the level increased or decreased by said volume control amplifier to the L channel signal delayed by said second delay unit, and
said second adder adds the center channel signal having the in level increased or decreased by said volume control amplifier to the R channel signal delayed by said third delay unit.

8. A sound field control method of controlling a sound field of input signals including a center channel signal for a center loudspeaker, a is left (L) channel signal for a left (L) channel loudspeaker, and a right (R) channel signal for a right (R) channel loudspeaker by using a plurality of loudspeakers including the L channel loudspeaker and the R channel loudspeaker, the center loudspeaker being located in front of a listening location, the L channel loudspeaker being located to front left of the listening location, the R channel loudspeaker being located to front right of the listening location, and said sound field control method comprising:
comparing, by a level comparison unit, a level of the center channel signal to a maximum value of levels of a plurality of other signals included in the input signals;
selectively increasing and decreasing, by a volume control amplifier, the level of the center channel signal; and
controlling, by a level control unit, the volume control amplifier to increase the level of the center channel signal when the level comparison unit determines by said comparing that the level of the center channel signal is lower than the maximum value.

9. A content reproduction apparatus comprising said sound field control apparatus according to claim 1, said content reproduction apparatus being one of a television set and an amplifier.

10. An integrated circuit comprising said level comparison unit, said volume control amplifier, said first adder, said second adder, and said level control unit which are included in said sound field control apparatus according to claim 1.
